(19) United States
(12) Patent Application Publication
(10) Pub. No.: US 2014/0333860 A1
(43) Pub. Date: Nov. 13, 2014

(54) THREE-DIMENSIONAL DISPLAY INSTALLATION

(71) Applicant: Hannstar Display Corporation, New Taipei City (TW)

(72) Inventors: Ra-Bin Li, Tainan City (TW); Heng-Cheng Tseng, Chiayi County (TW)

(21) Appl. No.: 14/340,566

(22) Filed: Jul. 25, 2014

Related U.S. Application Data
(62) Division of application No. 13/081,687, filed on Apr. 7, 2011.

(30) Foreign Application Priority Data
Jun. 23, 2010 (TW) 99120542

(51) Int. Cl. G02B 27/26

(52) U.S. Cl. CPC G02B 27/26
USPC 349/15

(57) ABSTRACT

A three-dimensional (3D) display installation is disclosed. The installation comprises a display, a phase-modulation device and at least a pair of polarized glasses. The phase-modulation device is set in one side of the display panel. The driving frequency of the display panel and the phase-modulation are above 120 Hz and synchronous with each other. The modulated polarized light contains left eye and right eye signals in sequence, which can be filtered by polarized glasses alternatively, and then the 3D visual effect is achieved. The 3D installation is suitable for multiple viewers at the same time, and the resolution of the screen is also unchanged under the 3D display mode.

### CROSS-REFERENCE TO RELATED APPLICATION

This application is a divisional application of and claims the priority benefit of a prior application Ser. No. 13/081,687, filed on Apr. 7, 2011, now pending. The prior application Ser. No. 13/081,687 claims the priority benefit of Taiwan application serial no. 99120542, filed on Jun. 23, 2010. The entirety of each of the above-mentioned patent applications is hereby incorporated by reference herein and made a part of this specification.

### FIELD OF THE INVENTION

The present invention relates to a three-dimensional display installation, and more particularly to a low cost three-dimensional display installation, which is suitable for multiple viewers at the same time and in which the resolution of the screen is also unchanged under the 3d display mode.

### BACKGROUND OF THE INVENTION

Current three-dimensional display techniques can be classified into many types, such as active glasses technology, passive glasses technology, colored glasses technology, polarized glasses technology, wavelength multiplexing technology, head-mounted displays, naked eye 3D technology, and space division multiplexing technology and time division multiplexing technology for flat panel displays, etc.

Among these technologies, the technical principle of active glasses (i.e. shutter glasses) is that left and right eye images are displayed on the screen at twice the frequency alternately. The shutter glasses dynamically shield the left eye and the right eye of the user. When the left eye image is displayed on the screen, the shutter glasses shield the right eye, and when the right eye image is displayed on the screen, the shutter glasses shield the left eye, so that the two eyes see different images, and then the 3D visual effect is achieved.

Another more common technique involves adding an alternating polarizer to a liquid crystal screen, in which half of the pixels on the screen display a left eye image and the other half of the pixels display a right eye image. After light passes through the odd number rows of pixels on the liquid crystal screen and polarizers, the polarized light of the vertical direction passes to display the left eye image; after light passes through the even number rows of pixels on the liquid crystal screen and polarizers, the polarized light of the horizontal direction passes to display the right eye image. The user only needs to wear polarized glasses with a linear polarizer for vertical polarization on the left eye and with a linear polarizer for horizontal polarization on the right eye, so that the user can see the left eye image only through the left eye and see the right eye image only through the right eye, respectively, and then the 3D visual effect is achieved.

However, the drawbacks of the above-mentioned shutter glasses are higher cost, easily damaged, cumbersome, and more suitable for a single viewer but not suitable for multiple viewers at the same time. The drawback of the technique of adding an alternating polarizer to a liquid crystal screen is that the resolution under the 3D display mode is only one-half of the original resolution of the screen panel, namely, one half resolution of the screen is sacrificed. Furthermore, it is easy to cause an alignment problem in such a technique. All of them are technical issues to be addressed.

### SUMMARY OF THE INVENTION

In view of various problems of the prior art, the inventors propose a three-dimensional display installation based on their research and development for many years and plenty of practical experience to overcome the drawbacks mentioned above.

It is an object of the present invention to provide a three-dimensional display installation suitable for multiple viewers at the same time.

Another object of the invention is to provide a three-dimensional display installation in which the resolution of the screen is unchanged under the 3D display mode without sacrifice of one half resolution of the screen.

A further object of this invention is to provide a low cost three-dimensional display installation.

Yet another object of the present invention is to provide a three-dimensional display installation comprising a display, a phase-modulation device and at least a pair of polarized glasses. The phase-modulation device is, for example, an optically compensated birefringence mode (OCB mode) or a twisted nematic mode (TN mode) liquid crystal display. The phase-modulation device is set on one side of the display. The driving frequencies of the display and the phase-modulation device are synchronous with each other. Preferably, the driving frequencies are above 120 Hz. In the present invention, the phase-modulation device is set on the light outputting surface of the display, and the driving frequencies of the display and the phase-modulation device are synchronous with each other. After the user wears the polarized glasses, the modulated polarized light contains left eye and right eye signals in sequence, which can be filtered by the polarized glasses alternatively, and then the 3D visual effect is achieved. It is very easy and convenient no matter how many viewers at the same time and has no need to sacrifice one half resolution of the screen. Besides, it is cheaper and at lower cost as compared to higher-cost shutter glasses technology.

The technical characteristics and achieved effects of the present invention may be further understood and appreciated from the following detailed description of the preferred embodiment.

### BRIEF DESCRIPTION OF THE DRAWINGS

The preferred embodiments of the three-dimensional display installation according to the present invention will be described with reference to the related drawings. For the convenience of understanding, the same reference numerals as in the following embodiments designate the same elements.

FIG. 1 is a three-dimensional schematic view of the present invention.

FIG. 2 is a schematic view of a phase-modulation device according to the present invention.

FIG. 3 is a schematic view of a first embodiment of the present invention.

FIG. 4 is a schematic view of a first embodiment of the present invention.

FIG. 5 is a schematic view of a first embodiment of the present invention.

FIG. 6 is a schematic view of a second embodiment of the present invention.

FIG. 7 is a schematic view of a second embodiment of the present invention.

FIG. 8 is a schematic view of a second embodiment of the present invention.

### DETAILED DESCRIPTION OF DISCLOSED EMBODIMENTS

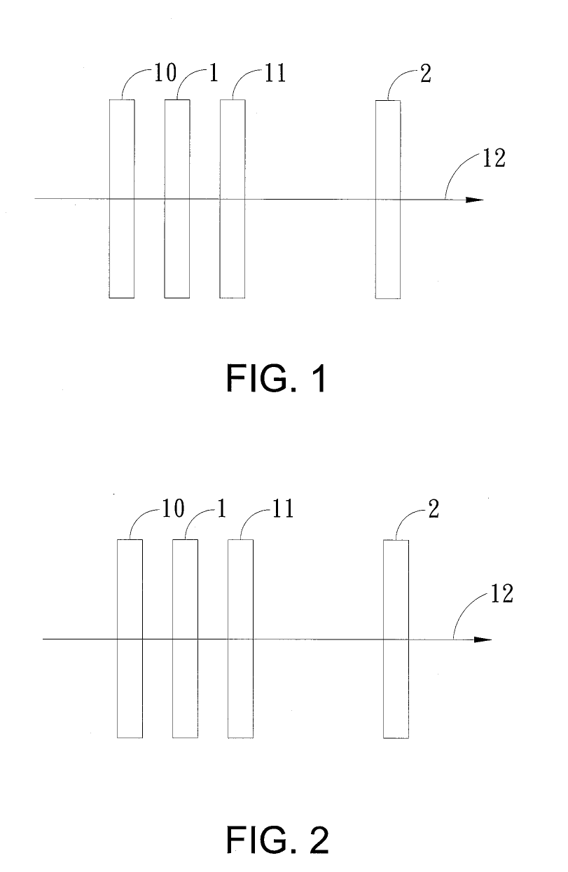

First, referring to FIG. 1, it depicts a three-dimensional schematic view of the present invention. A three-dimensional display installation according to the present invention comprises a display 1, a first polarizer 10, a second polarizer 11 and a phase-modulation device 2. The first polarizer 10 is set on one side of the display 1, and the second polarizer 11 is set on the other side of the display 1. The phase-modulation device 2 must meet the requirement of quick response, and for example, is an optically compensated birefringence mode or a twisted nematic mode liquid crystal display. The phase-modulation device 2 is set on the side of the second polarizer 11 different from the side whereon the display 1 is set. The display 1, the first polarizer 10, the second polarizer 11 and the phase-modulation device 2 are orthogonal to a light transmission direction 12. The driving frequencies of the display 1 and the phase-modulation device 2 are synchronous with each other. Preferably, the driving frequencies are above 120 Hz.

Referring to FIG. 2, it depicts a schematic view of a phase-modulation device according to the present invention. The phase-modulation device 2 further comprises a first substrate 21, a second substrate 22, a first orientation layer 23, a second orientation layer 24 and a liquid crystal layer 25. The various components are sequentially arranged from bottom to top in the order: the first substrate 21, the first orientation layer 23 set on the first substrate 21, the liquid crystal layer 25 set on the first orientation layer 23, the second orientation layer 24 set on the liquid crystal layer 25, and the second substrate 22 set on the second orientation layer 24. The first orientation layer 23 has a first orientation direction 231. The second orientation layer 24 has a second orientation direction 241. The first orientation direction 231 is parallel to the second orientation direction 241.

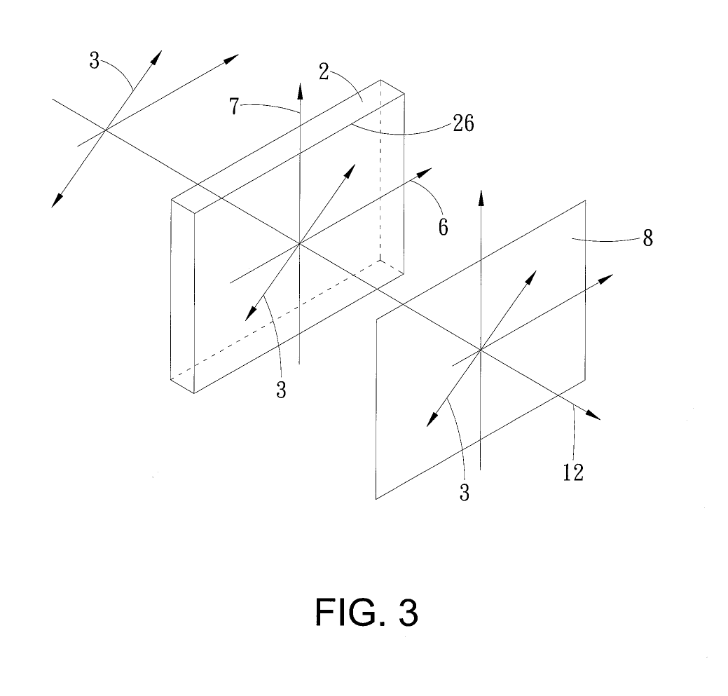

Next, referring to FIG. 3, it depicts a schematic view showing the phase modulation of a first embodiment of the present invention. It is explained that linearly polarized light 3 passes through the phase-modulation device 2. In FIG. 3, for the convenience of understanding the present invention, a transversal axis 6 parallel to the long side 26 of the phase-modulation device 2, a longitudinal axis 7 perpendicular to the long side 26 and a plane 8 perpendicular to the light transmission direction 12 are depicted only for an auxiliary purpose and will be explained in no more details. The linearly polarized light 3 outputted from the display 1 (as shown in FIG. 1) is incident on the phase-modulation device 2. If the phase-modulation device 2 does not modulate the incident light—for example, if the input voltage of the phase-modulation device 2 is 6 volts, the polarization direction of a single ray of the linearly polarized light 3 is unchanged such that the phase difference between the linearly polarized light 3 incident on the phase-modulation device 2 and the linearly polarized light 3 emitting from the phase-modulation device 2 is zero, that is, the linearly polarized light 3 emits from the phase-modulation device 2 in the same polarization direction as the direction of the incident linearly polarized light 3.

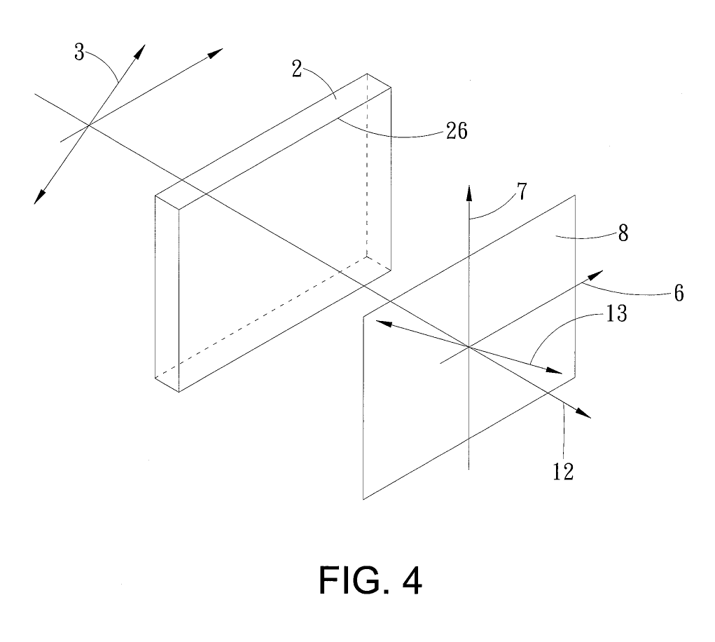

Next, referring to FIG. 4, it depicts a schematic view showing the modulation of a first embodiment of the present invention. It is also explained that linearly polarized light 3 passes through the phase-modulation device 2. The linearly polarized light 3 outputted from the display 1 (as shown in FIG. 1) is incident on the phase-modulation device 2. If the phase-modulation device 2 modulates the incident light—for example, if the input voltage of the phase-modulation device 2 is zero, the polarization direction of the linearly polarized light 3 is changed such that the phase difference between the linearly polarized light 3 incident on the phase-modulation device 2 and the linearly polarized light 13 emitting from the phase-modulation device 2 is π, that is, the polarization direction of the linearly polarized light 3 emitting from the phase-modulation device 2 and the polarization direction of the linearly polarized light 3 incident on the phase-modulation device 2 are orthogonal to each other.

It must be particularly explained that the above-mentioned first orientation direction 231 and second orientation direction 241 may be parallel to the direction of the transversal axis 6 or the longitudinal axis 7. If the first orientation direction 231 and the second orientation direction 241 are parallel to the direction of the transversal axis 6, the first orientation direction 231 and the second orientation direction 241 intersect with the linearly polarized light 3 at an angle of 45 degrees.

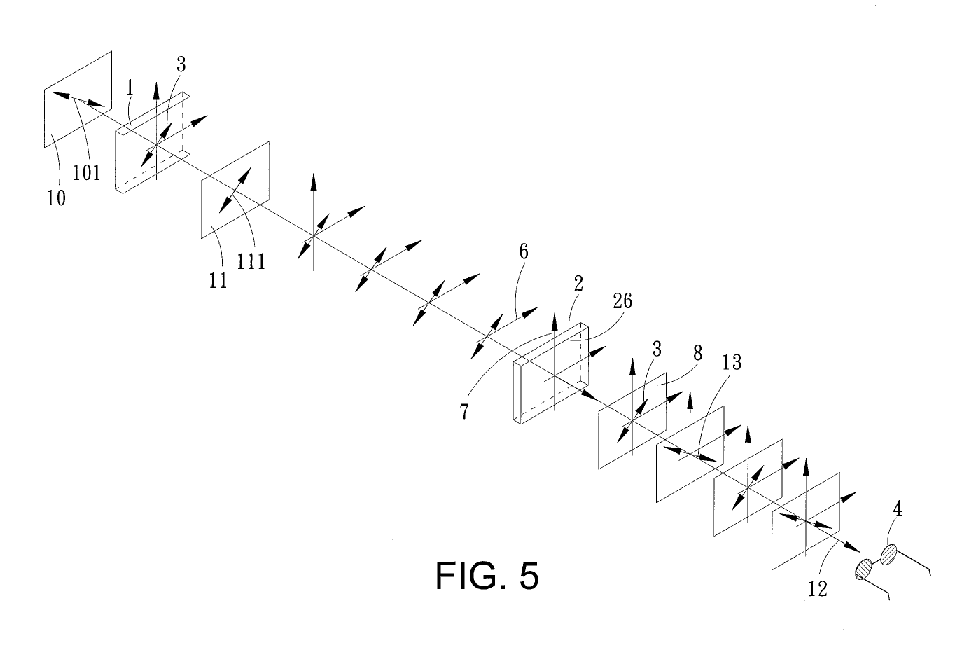

Also referring to FIG. 5, it depicts a schematic view showing the modulation of a first embodiment of the present invention. The display 1 is a twisted nematic mode liquid crystal display. The first polarizer 10 has a first transmission axis 101. The second polarizer 11 has a second transmission axis 111. The first transmission axis 101 and the second transmission axis 111 are orthogonal to each other. The display 1 sequentially outputs multiple rays of linearly polarized light 3 at a fixed frequency, and the phase-modulation device 2 is switched between the non-modulation and modulation states at a frequency synchronous with that of the display 1. After the multiple rays of linearly polarized light 3 are sequentially incident on the phase-modulation device 2, the polarization direction of the linearly polarized light 3 emitting from the phase-modulation device 2 is unchanged or orthogonal to the polarization direction of the linearly polarized light 3 incident on the phase-modulation device 2 alternatively, that is, the phase difference between the linearly polarized light 3 incident on the phase-modulation device 2 and the linearly polarized light 3 emitting from the phase-modulation device 2 is zero or the phase difference between the linearly polarized light 3 incident on the phase-modulation device 2 and the linearly polarized light 13 emitting from the phase-modulation device 2 is π. They emit from the phase-modulation device 2 alternatively. After the user wears linearly polarized glasses 4, the modulated linearly polarized light 13 contains left eye and right eye signals in sequence, which can be filtered by the polarized glasses alternatively—for example, the left eye receives the linearly polarized light 3 with a phase difference of zero and the right eye receives the linearly polarized light 13 with a phase difference of π, or the left eye receives the linearly polarized light 13 with a phase difference of π and the right eye receives the linearly polarized light 3 with a phase difference of zero, and then the 3D visual effect is achieved.

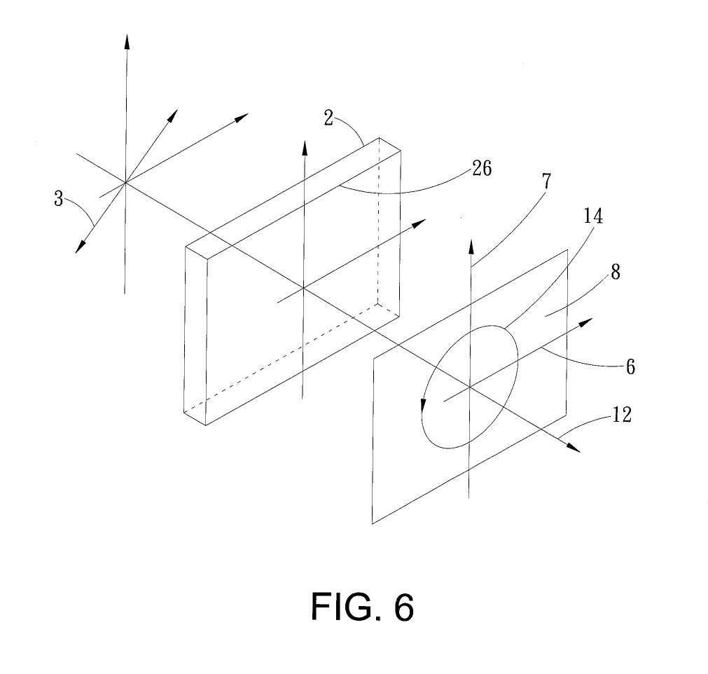

Next, referring to FIG. 6, it depicts a schematic view showing the phase modulation of a second embodiment of the present invention. It is explained that linearly polarized light 3 passes through the phase-modulation device 2. The linearly polarized light 3 outputted from the display 1 (as shown in FIG. 1) is incident on the phase-modulation device 2. If the phase-modulation device 2 modulates the incident light, the polarization direction of the linearly polarized light 3 is changed such that the phase difference between the linearly polarized light 3 incident on the phase-modulation device 2 and the left circularly polarized light 14 emitting from the phase-modulation device 2 is π/2, that is, the linearly polarized light 3 is changed into the left circularly polarized light 14 and emits from the phase-modulation device 2.

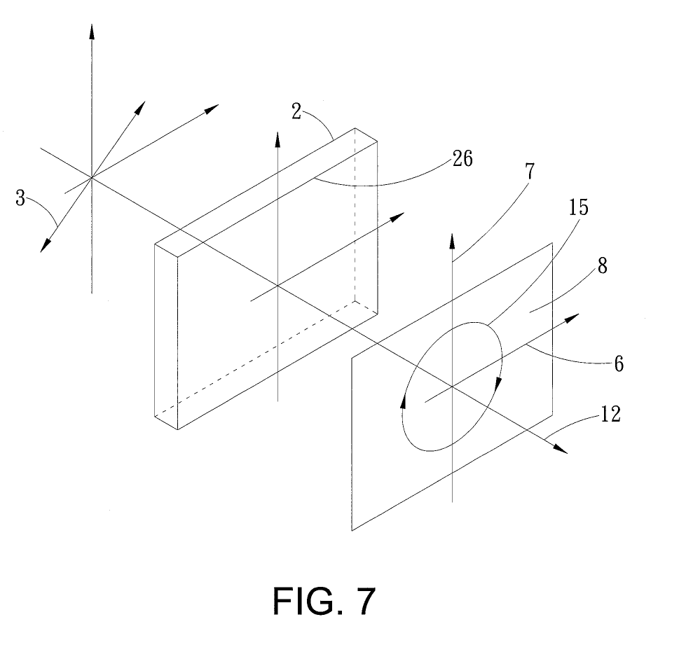

Next, referring to FIG. 7, it depicts a schematic view showing the modulation of a second embodiment of the present invention. It is also explained that linearly polarized light 3 passes through the phase-modulation device 2. The linearly polarized light 3 outputted from the display 1 (as shown in FIG. 1) is incident on the phase-modulation device 2. If the phase-modulation device 2 modulates the incident light, the polarization direction of the linearly polarized light 3 is changed such that the phase difference between the linearly polarized light 3 incident on the phase-modulation device 2 and the right circularly polarized light 15 emitting from the phase-modulation device 2 is 3 π/2, that is, the linearly polarized light 3 is changed into the right circularly polarized light 15 and emits from the phase-modulation device 2.

It must be particularly explained that the above-mentioned first orientation direction 231 and second orientation direction 241 may be the same direction as that of the transversal axis 6 or the longitudinal axis 7. If the first orientation direction 231 and the second orientation direction 241 are the same direction as that of the transversal axis 6, the first orientation direction 231 and the second orientation direction 241 intersect with the linearly polarized light 3 at an angle of 45 degrees.

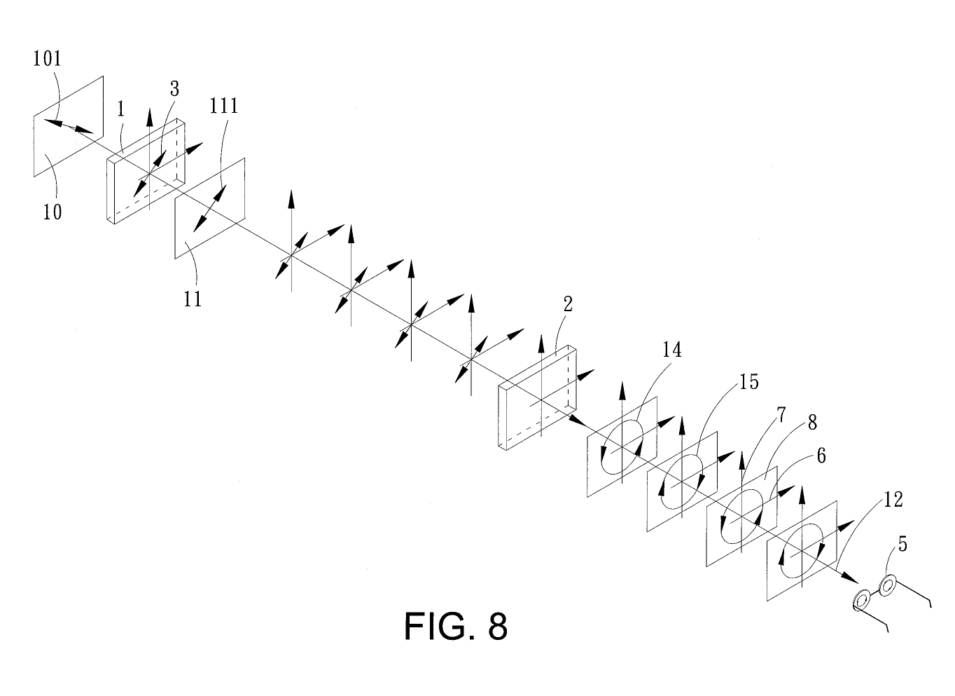

Also referring to FIG. 8, it depicts a schematic view showing the modulation of a second embodiment of the present invention. The display 1 is a twisted nematic mode liquid crystal display. The first polarizer 10 has a first transmission axis 101. The second polarizer 11 has a second transmission axis 111. The first transmission axis 101 and the second transmission axis 111 are orthogonal to each other. The display 1 sequentially outputs multiple rays of linearly polarized light 3 at a fixed frequency, and the phase-modulation device 2 is switched at a frequency synchronous with that of the display 1. After the multiple rays of linearly polarized light 3 are sequentially incident on the phase-modulation device 2, the linearly polarized light 3 is modulated into the left circularly polarized light 14 or the right circularly polarized light 15 alternatively, that is, the phase difference between the linearly polarized light 3 incident on the phase-modulation device 2 and the left circularly polarized light 14 emitting from the phase-modulation device 2 is π/2 and the phase difference between the linearly polarized light 3 incident on the phase-modulation device 2 and the right circularly polarized light 15 emitting from the phase-modulation device 2 is 3 π/2. They emit from the phase-modulation device 2 alternatively. After the user wears circularly polarized glasses 5, the left circularly polarized light 14 or the right circularly polarized light 15 contains left eye and right eye signals in sequence, which can be filtered by the polarized glasses alternatively—for example, the left eye receives the left circularly polarized light 14 with a phase difference of π/2 and the right eye receives the right circularly polarized light 15 with a phase difference of 3 π/2, or the left eye receives the right circularly polarized light 15 with a phase difference of 3 π/2 and the right eye receives the left circularly polarized light 14 with a phase difference of π/2, and then the 3D visual effect is achieved.

It must be particularly explained that in the above-mentioned FIGS. 3 to 8, for the convenience of understanding the present invention, a transversal axis parallel to the long side of the phase-modulation device, a longitudinal axis perpendicular to the long side and a plane perpendicular to the light transmission direction are depicted only for an auxiliary purpose and will be explained in no more details.

As described above, the present invention at least has the following advantages:

1. Suitable for multiple viewers at the same time:

In this invention, the phase-modulation device is set on one side of the display, and the driving frequencies of the display and the phase-modulation device are synchronous with each other. The user only needs to wear the polarized glasses, so that the modulated polarized light contains left eye and right eye signals in sequence, which can be filtered by the polarized glasses alternatively, and then the 3D visual effect is achieved. It is very easy and convenient no matter how many viewers at the same time and also suitable for multiple viewers at the same time.

2. The resolution of the screen is unchanged:

In this invention, the phase-modulation device is set on the light outputting surface of the display without sacrifice of one half resolution of the screen, that is, the resolution of the screen is unchanged under the 3D display mode.

3. Low cost:

The user wears low cost polarized glasses. It is cheaper and at lower cost as compared to higher-cost shutter glasses technology.

The above description is illustrative only and is not to be considered limiting. Various modifications or changes can be made without departing from the spirit and scope of the invention. All such equivalent modifications and changes shall be included within the scope of the appended claims.

What is claimed is:

1. A three-dimensional display installation comprising a display, a phase-modulation device and at least a pair of polarized glasses;
the phase-modulation device being set on one side of the display, a driving frequency of the display and a driving frequency of the phase-modulation device being synchronous with each other; and
a polarized light containing left eye and right eye signals in sequence being able to be received by the polarized glasses alternatively, and then the 3D visual effect being achieved, wherein the polarized light is a circularly polarized light and the polarized glasses are circularly polarized glasses.

2. The three-dimensional display installation of claim 1, wherein the phase-modulation device is a liquid crystal display.

3. The three-dimensional display installation of claim 2, wherein the liquid crystal display is an optically compensated birefringence mode liquid crystal display.

4. The three-dimensional display installation of claim 2, wherein the liquid crystal display is a twisted nematic mode liquid crystal display.

5. The three-dimensional display installation of claim 1, wherein the driving frequencies of the display and the phase-modulation device are above 120 Hz.

6. The three-dimensional display installation of claim 1, wherein the phase-modulation device further comprises a first substrate, a second substrate, a first orientation layer, a second orientation layer and a liquid crystal layer, the first orientation layer is set on the first substrate, the liquid crystal layer is set on the first orientation layer, the second orientation layer is set on the liquid crystal layer, the second substrate is set on the second orientation layer, the first orientation layer has a first orientation direction, the second orientation layer has a second orientation direction, and the first orientation direction is parallel to the second orientation direction.

7. The three-dimensional display installation of claim 1, wherein a first polarizer is further set on one side of the display, a second polarizer is further set on the side of the display, the phase-modulation device is set on one side of the second polarizer different from the side whereon the display is set, and the display, the first polarizer, the second polarizer and the phase-modulation device are orthogonal to a light transmission direction.

8. The three-dimensional display installation of claim 7, wherein the first polarizer has a first transmission axis, the second polarizer has a second transmission axis, and the first transmission axis and the second transmission axis are orthogonal to each other.
